(19) United States
(12) Patent Application Publication
(10) Pub. No.: US 2012/0187864 A1
(43) Pub. Date: Jul. 26, 2012

(54) LIGHTING DEVICE AND LUMINAIRE

(75) Inventors: Naoko IWAI, Yokosuka-shi (JP); Hiroshi Kubota, Yokosuka-shi (JP); Masahiko Kamata, Yokosuka-shi (JP); Hiroshi Terasaka, Yokosuka-shi (JP)

(73) Assignee: Toshiba Lighting & Technology Corporation, Yokosuka-shi (JP)

(21) Appl. No.: 13/354,826

(22) Filed: Jan. 20, 2012

(30) Foreign Application Priority Data
Jan. 21, 2011 (JP) 2011-011392

(51) Int. Cl. H05B 37/00

(52) U.S. Cl. 315/291

(57) ABSTRACT

According to one embodiment, a lighting device includes a lighting circuit. The lighting circuit includes a direct-current power supply and a DC-DC converter, and lights an illumination lamp by constant-current control. An output capacitor is connected in parallel to an output end of the DC-DC converter. A capacitance of the output capacitor is set to such a value that a peak value of a pulse-like current flowing when the illumination lamp is instantaneously detached from and attached to the output end of the DC-DC converter is one or more and four or less times a load current of the illumination lamp.

### INCORPORATION BY REFERENCE

The present invention claims priority under 35 U.S.C. §119 to Japanese Patent Application No. 2011-011392 filed on Jan. 21, 2011. The content of the application is incorporated herein by reference in their entirety.

### FIELD

Embodiments described herein relate generally to a lighting device to light an illumination lamp and a luminaire.

### BACKGROUND

Since an illumination lamp using, for example, an LED as a light source is lit by direct-current power, if a lighting circuit is constructed using a DC-DC converter, there is a merit that the control is easy and the circuit efficiency is high. An output end of the DC-DC converter is constructed such that an output capacitor is connected to the output end, and a high frequency ripple current generated by the operation of the DC-DC converter is bypassed so as to prevent the current from flowing to the illumination lamp.

The illumination lamp is detached from and attached to the output end of the lighting circuit at the time of replacement or check thereof, and at that time, there is a case where connection between the illumination lamp and the lighting circuit is insufficient. Besides, there is a case where the luminaire or the illumination lamp receives a shock or vibration from the outside during lighting of the illumination lamp. As a result of these, the connection between the illumination lamp and the lighting circuit is instantaneously detached and is again connected, that is, instantaneous detachment and attachment is performed. The luminaire is required to be constructed so that even if such a state occurs, the illumination lamp or the like is not damaged.

When the lighting circuit is constant-current controlled, and when the illumination lamp under lighting is opened during the lighting, since a load current is made to flow at that time, the voltage of the output end of the lighting circuit abruptly rises. By this, the terminal voltage of the output capacitor rises. When the illumination lamp is again connected to the output end of the lighting circuit in such a state, the raised terminal voltage of the output capacitor is applied to the illumination lamp.

However, in the related art luminaire, importance is given to the bypassing function of the high frequency ripple current, and the capacitance of the output capacitor is set to 2 μF or more. Thus, at the time of reconnection in the instantaneous detachment and attachment of the illumination lamp from and to the lighting circuit, a very large current flows like a pulse. As a result, the light source of the illumination lamp, for example, the LED is apt to deteriorate, and the life is apt to become short.

An advantage of an exemplary embodiment is to provide a lighting device and a luminaire, in which a pulse-like current flowing at the time of reconnection in instantaneous detachment and attachment of an illumination lamp from and to a lighting circuit is reduced, and the deterioration of a light source of the illumination lamp and the life shortening are prevented, and when the illumination lamp is made a load, a bypassing function of a high frequency ripple current expected for an output capacitor is maintained at a desired level, and the occurrence of flicker of light is prevented.

### BRIEF DESCRIPTION OF THE DRAWINGS

FIG. 1 is a circuit view of a lighting circuit of a luminaire of an embodiment.

FIGS. 2(a) and 2(b) are waveform views for explaining a pulse-like current flowing at the time of reconnection in instantaneous detachment and attachment of an illumination lamp from and to the lighting circuit of the luminaire, in which FIG. 2(a) is a waveform view of an output voltage waveform and FIG. 2(b) is a waveform view of a load current waveform.

### DETAILED DESCRIPTION

In general, according to one embodiment, a lighting device includes a lighting circuit. The lighting circuit includes a direct-current power supply and a DC-DC converter, and lights an illumination lamp by constant-current control. An output capacitor is connected in parallel to an output end of the DC-DC converter. Capacitance of the output capacitor is set to such a value that a peak value of a pulse-like current flowing when the illumination lamp is instantaneously detached from and attached to the output end of the DC-DC converter is one or more and four or less times a load current of the illumination lamp.

By this, the pulse-like current flowing at the time of reconnection in the instantaneous detachment and attachment of the illumination lamp from and to the lighting circuit is reduced, and the deterioration of a light source of the illumination lamp and the life shortening are prevented. Further, when the illumination lamp is made a load, the bypassing function of a high frequency ripple current expected for the output capacitor is maintained at a desired level, and the occurrence of flicker of light can be prevented.

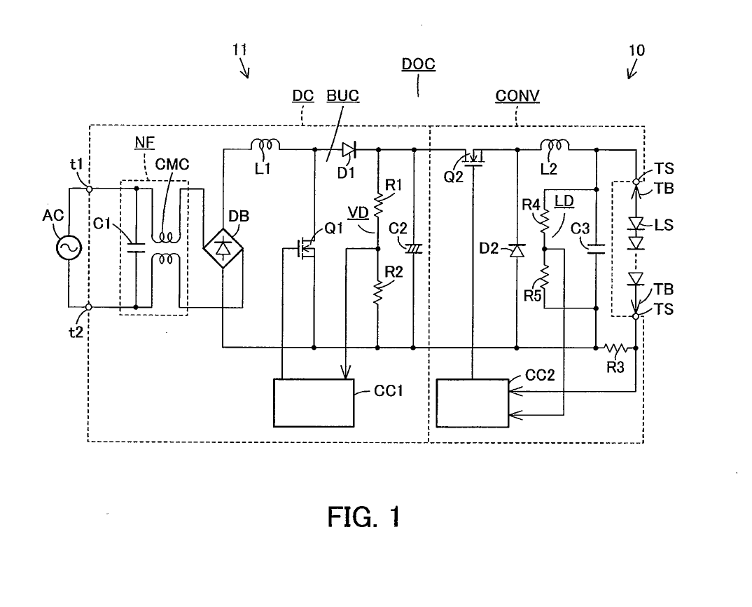

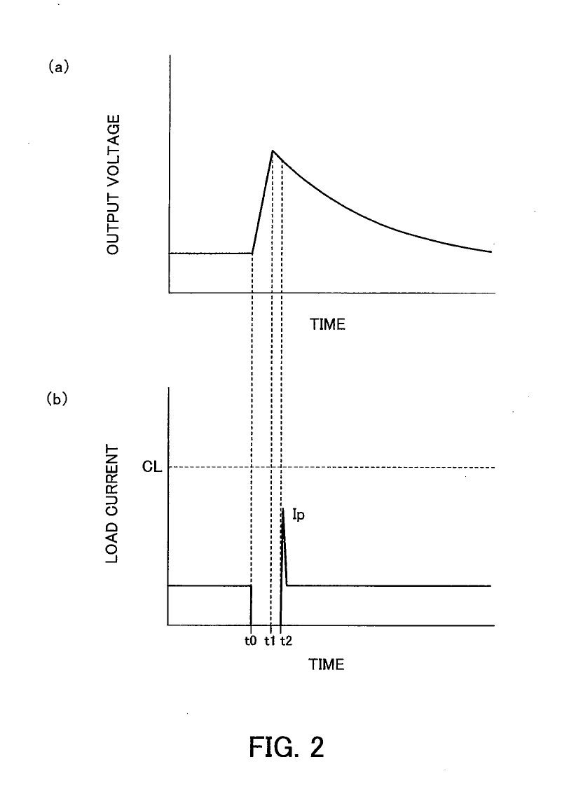

Hereinafter, an embodiment will be described with reference to FIG. 1 and FIG. 2.

As shown in FIG. 1, a luminaire 10 includes an illumination lamp LS and a lighting device 11. The lighting device 11 includes a lighting circuit DOC.

First, the illumination lamp LS will be described. The illumination lamp LS is an illumination lamp using an LED as a light source. The number of LEDs to be used is not specifically limited. In order to obtain a desired amount of light, plural LEDs may be provided. In this case, the plural LEDs can form a series-connected circuit or a series-parallel circuit. However, the illumination lamp LS may include a single LED. The light source of the illumination lamp LS is not limited to the LED, and may be an electro-luminescence (EL), an organic light-emitting diode (OLED), an organic electro-luminescence (OEL) or the like.

Besides, the illumination lamp LS includes a power receiving end TB to be connected to an output end TS of the lighting circuit DOC. Although the power receiving end TB has preferably a form of a cap, no limitation is made to this. Incidentally, as the cap, well-known various structures can be appropriately adopted. In brief, as long as a structure is for connection with the output end TS, the remainder of the structure is not specifically limited. For example, the power receiving end may have a form of a connector extended through a conductive wire from the main body of the illumination lamp LS. Besides, the power receiving end TB may be a connection conductor itself.

Further, the illumination lamp LS may have various forms. For example, the form may be a straight tube shape in which caps are provided at both ends, or a single cap shape, as in an incandescent lamp, in which a screw cap is provided at one end.

Further, a desired number of illumination lamps LS can be connected in series to or in parallel to the lighting circuit DOC. Incidentally, if the parallel connection is performed, a constant-current circuit is preferably made to intervene so that load currents flowing through the respective parallel circuits are equalized.

Incidentally, in the illustrated embodiment, the illumination lamp LS has a straight tube shape, plural series-connected LEDs are dispersed and arranged in a not-shown straight tube-shaped outer tube, and the power receiving ends TB formed at both ends form pin-shaped caps.

Next, the lighting circuit DOC will be described. The lighting circuit DOC includes input ends t1 and t2 connected to an alternating-current power supply AC and the output ends TS to which the illumination lamp LS is connected. The lighting circuit DOC supplies direct-current power to the illumination lamp LS through the output ends TS and lights the illumination lamp LS. The output end TS has only to be structured so as to be fitted with the power receiving end TB of the illumination lamp LS, and the remainder of the structure is not specifically limited. For example, although the form of the socket is preferable, if the power receiving end TB of the illumination lamp LS has a form of a connector, the output end TS may have a form of a connector receiver. Besides, if the power receiving end TB has a form of a connection conductor, the output end TS may have a form of a terminal stand to receive the connection conductor.

Besides, the lighting circuit DOC includes a DC-DC converter CONV and its direct-current power supply DC. As the DC-DC converter CONV, for example, various choppers are preferable since the conversion efficiency is high and the control is easy. The DC-DC converter CONV generally converts an input direct-current voltage into a direct-current voltage of different voltage and outputs the voltage. The output voltage is applied to the illumination lamp LS. The illumination lamp LS can be dimmed and lit to a desired level by controlling and adjusting the output of the DC-DC converter CONV.

If the lighting circuit DOC is mainly composed of the DC-DC converter CONV, the direct-current power supply DC and the DC-DC converter CONV can be arranged in one-to-one correspondence. Besides, the direct-current power supply DC is made common, plural DC-DC converters CONV are provided in one-to-plural correspondence, and the direct-current power supply DC may be supplied in parallel to the plural DC-DC converters CONV. Incidentally, in the latter case, when desired, the respective DC-DC converters CONV are provided at positions adjacent to the illumination lamp LS, and the common direct-current power supply DC can be provided at a position separate from the illumination lamp LS.

Further, although the lighting circuit DOC is constructed so as to constant-current control the output, a composite control characteristic may be provided such that in a partial region, for example, a region where the lighting power of the illumination lamp LS is low, in other words, in a deep dimming region, constant-voltage control is performed, and in the other region, constant-current control is performed.

Further, in order to change the operation state of the illumination lamp LS, the lighting circuit DOC can be constructed such that the output of the lighting circuit DOC can be varied so as to change the direct-current power supplied to the illumination lamp LS according to a control signal. That is, the illumination lamp LS can be dimmed and lit according to the dimming signal.

The DC-DC converter CONV converts the direct-current input supplied from the direct-current power supply DC, outputs a desired voltage, and lights the illumination lamp LS. The remainder of the structure is not specifically limited. Incidentally, the DC-DC converter CONV is a device to convert a direct-current power into a direct-current power of a different voltage, and is a device also called a forward conversion device. The DC-DC converter may be a flyback converter, a forward converter, a switching regulator or the like in addition to various choppers. Irrespective of the circuit system of the DC-DC converter CONV, an output capacitor C3 having a specified capacitance is connected to the output end.

In the illustrated embodiment, the DC-DC converter CONV is formed of a step-down chopper. A series circuit of a switching element Q2, an inductor L2 and the output capacitor C3 is connected to the output end of the direct-current power supply DC, that is, the output end of a booster chopper in this embodiment.

Besides, a series circuit of a diode D2 and the output capacitor C3 is connected in parallel to the inductor L2, and a closed circuit of those is formed. The output ends TS and TS are connected to both ends of the output capacitor C3 through a resistor R3 for current detection, so that the constant-current control step-down chopper is formed. The on and off of the switching element Q2 is controlled by a control circuit CC2. The voltage of the resistor R3 for current detection is control-inputted to the control circuit CC2, and controls the off of the switching element Q2. By this, the DC-DC converter CONV lights the illumination lamp LS by constant-current control.

The capacitance of the output capacitor C3 is set to such a specified value that the peak value of a pulse-like current flowing when the illumination lamp LS is instantaneously detached from and attached to the output end TS of the DC-DC converter CONV is one or more and four or less times the load current of the illumination lamp LS. The present inventors confirm that this condition is satisfied if the capacitance of the output capacitor C3 is 1 μF or less. If the capacitance of the output capacitor C3 is set as described above, even if the capacitance is small, a desired effect is obtained. That is, the peak value of the high frequency ripple current superimposed on the load current is reduced to an allowable value or less, that is, a maximum rated current value or less of the illumination lamp LS. As a result, it is found that the deterioration of the LED of the illumination lamp LS and the life shortening can be prevented, and when the illumination lamp LS is made a load, the bypassing function of the high frequency ripple current expected for the output capacitor C3 can be maintained at a desired level.

Incidentally, the maximum rated current value of the illumination lamp LS is a combined maximum forward direction current when all the LEDs in the illumination lamp LS are seen from the pair of power receiving ends TB and TB of the illumination lamp LS. However, when the single LED exists in the illumination lamp LS, it is needless to say that the maximum rated current value is the maximum forward direction current of the single LED. Besides, when the plural LEDs are connected in parallel with each other in the illumination lamp LS, the maximum rated current value is the number of parallel LEDs times the maximum forward direction current of the single LED.

Next, the pulse-like current flowing at the time of reconnection in the instantaneous detachment and attachment of the illumination lamp LS from and to the lighting circuit DOC in this embodiment will be described with reference to FIGS. 2(a) and 2(b). FIG. 2(a) shows an output voltage waveform of the lighting circuit DOC, and FIG. 2(b) shows a load current waveform. Times on the horizontal axes are coincident with each other.

At time t0, when the illumination lamp LS is instantaneously detached from the output end TS of the lighting circuit DOC and the load current is interrupted, since the lighting circuit DOC is constant-current controlled, the output voltage of FIG. 2(a) abruptly rises and reaches the peak at time t1, and the output capacitor C3 is charged with the high voltage. Thereafter, the voltage of the output capacitor C3 is gradually reduced. When the illumination lamp LS is reconnected at time t2 close to time t1, the electric charge of the output capacitor C3 charged with the high voltage is discharged through the illumination lamp LS. At that time, as shown in FIG. 2(b), a pulse-like current Ip superimposed on the load current flows. Incidentally, the peak value of the pulse-like current Ip is a value obtained by adding the load current value and the wave height value of the pulse-like portion of the pulse-like current Ip.

That is, since the capacitance of the output capacitor C3 is set as described above, the wave height value of the pulse-like current Ip does not exceed the maximum rated current value CL of the illumination lamp LS shown in FIG. 2(b), and the pulse duration time becomes a very short time of the order of ns (nano-seconds).

Incidentally, for reference, the circuit operation of the DC-DC converter CONY including the step-down chopper will be briefly described. When the switching element Q2 is turned on, a linearly increasing current flows into the inductor L2 through the switching element Q2 from the output end of the direct-current power supply DC, and electromagnetic energy is stored in the inductor L2. When the increasing current detected through the voltage of the resistor R3 reaches a specified value, the control circuit CC2 turns off the switching element Q2. When the switching element Q2 is turned off, the electromagnetic energy stored in the inductor L2 is released, and a linearly decreasing current flows. When the decreasing current becomes 0, the control circuit CC2 again turns on the switching element Q2. Thereafter, the foregoing operation is repeated.

As long as the direct-current power supply DC includes a circuit that converts alternating current supplied from the alternating-current power supply AC into direct current and supplies the direct-current power, as the input, to the DC-DC converter CONY as the latter stage circuit element, the remainder of the structure is not specifically limited. The input end is connected to the alternating-current power supply AC through a noise filter circuit NF. In the illustrated embodiment, the direct-current power supply DC includes a rectifier circuit, a power factor improving circuit and a smoothing circuit. A bridge full-wave rectifier circuit DB is used as the rectifier circuit. Besides, a booster chopper circuit BUC is provided as the power factor improving circuit and the smoothing circuit. Incidentally, in the above structure, an alternating-current input end of the bridge full-wave rectifier circuit DB is the input end of the direct-current input power supply DC.

In the booster chopper circuit BUC, a series circuit of an inductor L1 and a switching element Q1 is connected between the direct-current output ends of the bridge full-wave rectifier circuit DB, and a series circuit of a diode D1 and a smoothing capacitor C2 is connected in parallel to the switching element Q1. Both ends of the smoothing capacitor C2 are output ends of the direct-current power supply DC.

A voltage dividing circuit VD including a series circuit of resistors R1 and R2 is connected in parallel to the smoothing capacitor C2, and the output voltage of the direct-current power supply DC is divided and is feedback-inputted to a control circuit CC1.

The control circuit CC1 supplies a drive signal to a control terminal of the switching element Q1 to control switching thereof, and controls the switching element Q1 so as to improve the power factor of the direct-current power supply DC with respect to the alternating-current power supply AC. Incidentally, for example, a MOSFET is used as the switching element Q1, and a gate terminal thereof is applied with a gate drive signal voltage from the control circuit CC1.

Next, the circuit operation of the direct-current power supply DC will be briefly described. When the switching element Q1 is turned on, a linearly increasing current flows from the direct-current power supply DC to the inductor L1, and electromagnetic energy is stored in the inductor L1. When the terminal voltage of the smoothing capacitor C2 reaches a specified value, the control circuit CC1 turns off the switching element Q1. By this, the electromagnetic energy stored in the inductor L1 is released, and a linearly decreasing current flows through a circuit of the inductor L1, the diode D1, the smoothing capacitor C2 and the bridge full-wave rectifier circuit DB. By repeating the above circuit operation, a direct-current voltage which is smoothed, is boosted to become higher than the alternating-current voltage, and is constant-voltage controlled is generated between both ends of the smoothing capacitor C2, that is, between the output ends of the direct-current power supply DC, and is outputted from the direct-current power supply DC.

In the illustrated embodiment, the lighting circuit DOC includes the noise filter circuit NF and a load state detection circuit LD as sub-components in addition to the direct-current power supply DC and the DC-DC converter CONV.

The noise filter circuit NF prevents an erroneous operation due to noise entering from a power supply line, and prevents noise generated in the lighting circuit DOC from leaking to the power supply line. Then, one end of the noise filter circuit is connected to the input end t1, t2 of the lighting circuit DOC, and the other end is connected to the input end of the direct-current power supply DC.

Although the specific circuit structure of the noise filter circuit NF is not specifically limited, well-known various noise filter circuits can be suitably selected and used. In the illustrated embodiment, the noise filter circuit includes a capacitor C1 and common mode choke coils CMC. The capacitor C1 is connected between the input ends t1 and t2. The common mode choke coils CMC are respectively inserted in series to a pair of lines between the capacitor C1 and the direct-current power supply DC.

The load state detection circuit LD includes a voltage dividing circuit including resistors R4 and R5, is connected to the pair of output ends TS and TS of the DC-DC converter CONV, and detects the output voltage of the lighting circuit DOC. When the value thereof exceeds a specified value, the load state detection circuit controls the DC-DC converter CONV to cause a safety operation to be performed. Accordingly, the contact resistance of the connection part between the output end TS of the lighting circuit DOC and the power receiving end TB of the illumination lamp LS becomes large and when there arises a fear of an abnormal temperature rise, or when there is a fear that a circuit is opened at the connection part or the like and an arc discharge occurs, the output of the lighting circuit DOC is reduced or stopped, and safety can be achieved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lighting device comprising:
a lighting circuit that includes a direct-current power supply, a DC-DC converter having an input end connected to the direct-current power supply, and an output capacitor connected in parallel to an output end of the DC-DC converter, and lights an illumination lamp connected to the output end of the DC-DC converter by constant-current control, wherein
a capacitance of the output capacitor is set to a value, and a peak value of a pulse-like current flowing when the illumination lamp is instantaneously detached from and attached to the output end of the DC-DC converter is one or more and four or less times a load current of the illumination lamp.

2. The device of claim 1, wherein the capacitance of the output capacitor is 1 μF or less.

3. A lighting device comprising:
a lighting circuit that includes a direct-current power supply, a DC-DC converter having an input end connected to the direct-current power supply, and an output capacitor connected in parallel to an output end of the DC-DC converter, and lights an illumination lamp connected to the output end of the DC-DC converter by constant-current control, wherein
a capacitance of the output capacitor is set to a value, and a peak value of a pulse-like current flowing when the illumination lamp is instantaneously detached from and attached to the output end of the DC-DC converter is equal to or less than a maximum rated current value of the illumination lamp.

4. A lighting device comprising:
a lighting circuit that includes a direct-current power supply, a DC-DC converter having an input end connected to the direct-current power supply, and an output capacitor having a capacitance of 1 μF or less and connected in parallel to an output end of the DC-DC converter, and lights an illumination lamp connected to the output end of the DC-DC converter by constant-current control.

5. The device of claim 1, wherein the DC-DC converter is one of a chopper, a flyback converter, a forward converter and a switching regulator.

6. The device of claim 1, wherein the direct-current power supply converts an alternating-current power supplied from an alternating-current power supply into a direct-current power and supplies the direct-current power to the DC-DC converter.

7. A luminaire comprising:
an illumination lamp; and
a lighting device of claim 1.

8. The luminaire of claim 7, wherein the illumination lamp includes, as a light source, one of an LED, an EL, an organic light-emitting diode and an organic EL.
